(19) United States
(12) Patent Application Publication
(10) Pub. No.: US 2014/0335992 A1
(43) Pub. Date: Nov. 13, 2014

(54) ROTARY POWER TRANSFER DISCONNECT DEVICE

(71) Applicant: SCHAEFFLER TECHNOLOGIES GMBH & CO. KG, Herzogenaurach (DE)

(72) Inventors: Brian Lee, York, SC (US); Carsten Ohr, Charlotte, SC (US)

(73) Assignee: SCHAEFFLER TECHNOLOGIES GMBH & CO. KG, Herzogenaurach (DE)

(21) Appl. No.: 14/259,310

(22) Filed: Apr. 23, 2014

Related U.S. Application Data
(60) Provisional application No. 61/820,876, filed on May 8, 2013.

(51) Int. Cl. F16H 48/10; F16H 48/24

(52) U.S. Cl. CPC F16H 48/10; F16H 48/24
USPC 475/248; 475/269

(57) ABSTRACT

A rotary power transfer disconnect device for use between first and second drive parts, with the first having an opening with teeth defined therein, and the second having external teeth located at least partially in the opening. A gap is located between the teeth so that the first drive part is rotatable relative to the second drive part. A sliding dog clutch having a spline sleeve with internal projections located on an inner periphery thereof that are engagable with the teeth on the outer periphery of the second drive part and external projections located on an outer periphery thereof that are engagable with the teeth on the inner periphery of the opening of the first drive part is slidable into the gap for driving engagement between the teeth and out of the gap to allow relative rotation between the first and second parts.

### FIELD OF THE INVENTION

The present invention is in the field of sliding dog clutches, and has particular application as a disconnect device for a motor vehicle differential as well as other power transfer arrangements.

### BACKGROUND

Rotary power transfer disconnect devices are used commonly in many power transfer applications. One known arrangement involves a sliding dog clutch formed by a sliding sleeve having internal teeth or splines which is slid from a disengaged position in which it engages only the splines on one shaft to an engaged position wherein it is slid partially onto the splines of an axially aligned, abutting shaft such that the coupling body is engaged over both axially abutting shaft ends and the entire load is transferred through the coupling body via the engaged teeth or splines through shear and torsion. These arrangements typically have large axial space requirements and require the coupling sleeve to have a high load carrying configuration due to the loads transferred entirely through the coupling between the aligned axially abutting shafts.

FIG. 1 shows a schematic view of a vehicle drive train 2 used in connection with a front wheel drive/all-wheel drive vehicle. The arrangement includes the engine 4 arranged transversely adjacent to the front axles, the transmission 6 which is connected to a front differential 8 from which left and right front axle halves 10, 11 extend in order to drive the front wheels. A power transfer unit (PTU) 12 is connected to the front differential for transferring power via a drive shaft 14 to the rear wheels. The rear wheel drive shaft 14 is connected to a rear differential 16 from which the left and right rear axles 18, 19 extend. Additional features, such as CV joints which are required for steering of the front axles, a clutch or disconnect for uncoupling the rear wheels from the drive, as well as various other optional features have not been shown. Based on the new fleet mileage requirements coming into effect in the U.S., there has been an increasing need to reduce fuel consumption by all possible means. While prior front wheel drive/all-wheel drive vehicles may have previously driven the drive line connected to the rear wheels even when only front wheel drive was being used and provided separate disconnects or clutching mechanisms at the rear differential 16 or possibly at the wheel bearings for the rear wheels, in order to improve fuel economy when operating in a front wheel drive only mode, it is now desirable to entirely isolate the remainder of the drive line for driving the rear wheels. It has been shown that this can increase fuel economy by up to 5%.

Thus, in addition to the general need for a lighter weight, less space consuming rotary power transfer disconnect device that is still able to transfer high loads, there is particular need in connection with motor vehicles and in particular for disconnecting a drive line for the rear wheels in a front wheel drive/all-wheel drive equipped vehicle when only front wheel drive is being utilized.

### SUMMARY

In one aspect, a rotatory power transfer disconnect device is provided having a first drive part with an opening defined therein, with teeth defined around at least a portion of an inner periphery of the opening. A second drive part is provided that is at least partially received in the opening in the first drive part. The second drive part has teeth defined around at least a portion of an outer periphery that extends into the opening. A gap is located between the teeth on an inner periphery of the opening of the first drive part and the teeth defined on the outer periphery of the second drive part that extends into the opening, with the gap being sufficient so that the first drive part is rotatable relative to the second drive part. A sliding dog clutch having a spline sleeve with internal projections located on an inner periphery thereof that are engagable with the teeth on the outer periphery of the second drive part and external projections located on an outer periphery thereof that are engagable with the teeth on the inner periphery of the opening of the first drive part is provided. The sliding dog clutch is slidable between a first position in which the spline sleeve is located in the gap, providing a driving engagement between the first drive part and the second drive part, and a second position, in which the spline sleeve is disengaged from the teeth on the inner periphery of the opening of the first drive part or the teeth defined on the outer periphery of the second drive part, allowing relative rotation between the first drive part and the second drive part.

In one preferred arrangement, the spline sleeve is a thin-walled part. This is preferably a deep drawn part and can optionally be attached to an actuator ring for movement. In this arrangement, the thin-walled sleeve includes the internal projections in the form of internal teeth located on an inner periphery thereof that are preferably complementary to the teeth on the outer periphery of the second drive part and the external projections are in the form of external teeth located on an outer periphery thereof that are preferably complementary to the teeth on the inner periphery of the opening of the first drive part.

In another preferred arrangement, the spline sleeve is formed from a row of rollers held in a cage, and the cage can optionally be attached to an actuator ring for movement. In this arrangement, the portions of the rollers that extend radially inwardly from the cage form the internal projections and the portions of the rollers that extend radially outwardly from the cage form the external projections.

In another aspect, the spline sleeve is slidable on the second drive part, guided by the teeth defined on the outer periphery of the second drive part so that it can be moved into and out of engagement with the teeth defined around the inner periphery of the opening of the first drive part.

Preferably, the teeth on the inner periphery of the opening of the first drive part have a first width and the teeth defined on the outer periphery of the second drive part have a second width, and the first width is less than the second width. Additionally, it is preferred if the first width is entirely overlapped by the second width.

In another aspect, an actuator is provided that it adapted to move the spline sleeve between the first position and the second position. Preferably, the actuator includes an actuator ring connected to the spline sleeve, and the actuator ring includes actuating grooves that are engaged by an actuator pin of the actuator in order to move the spline sleeve to the second position. Here, it is preferred that a spring is used to bias the spline sleeve to the first position. However, an actuator could be used to move the spline sleeve in both directions.

In another aspect, the first drive part is a differential carrier and the second drive part is a power takeoff unit input shaft used in connection with a motor vehicle in order to provide a rotary power transfer disconnect between the front axle differential and the drive line used to drive the rear axles of a front wheel drive/all-wheel drive motor vehicle.

In this particular application, it is preferred that the spline sleeve is slidable on the power takeoff unit input shaft against the spring force of the spring located on the power takeoff unit input shaft. The spring is held in position on the power takeoff unit input shaft by a locking ring engaged in an annular groove on the power takeoff unit input shaft.

Further, preferably the power takeoff unit input shaft includes an annular flange that engages behind the opening which is defined in the differential carrier. In one preferred arrangement, the differential is a spur gear differential and the differential carrier carries two sets of spur gears and two sun gears. However, the coupling arrangement can also be used in connection with a conventional differential.

In another aspect, a spur gear differential with a power takeoff unit connection is provided. This includes a carrier with an opening defined therein, with the carrier housing two sun gears and two sets of planet gears. The sun gears include splined openings adapted to receive splined ends of the half axles. A collar is located on the carrier having an opening with teeth or splines located on an inner periphery thereof adapted for driving connection of a PTU input shaft. The PTU input shaft has teeth or splines defined around at least a portion of an outer periphery thereof that extends into the opening. A gap is located between the teeth on the inner periphery of the opening of the collar and the teeth defined on the outer periphery of the PTU input shaft that extends into the opening with the gap being large enough so that the carrier with the collar is rotatable relative to the PTU input shaft. A sliding dog clutch having a spline sleeve with internal projections located on an inner periphery thereof that are engagable with the teeth on the outer periphery of the PTU input shaft and external projections located on an outer periphery thereof that are engagable with the teeth on the inner periphery of the opening of the collar is provided. The sliding dog clutch is slidable between a first position, in which the spline sleeve is located in the gap providing a driving engagement between the collar of the carrier and the PTU input shaft, and a second position, in which the spline sleeve is disengaged from the teeth on the inner periphery of the opening of the collar of the carrier or the teeth defined on the outer periphery of the PTU input shaft, allowing relative rotation between the carrier and the PTU input shaft.

This arrangement allows for connection or disconnection of the PTU input shaft directly at the front axle differential, it is particularly useful in the space saving environment required in today's motor vehicles, specifically in connection with spur gear differentials. Further, due to the particular arrangement of the second drive part in the form of the PTU input shaft axially overlapping the first drive part in the form of the carrier, a light weight coupling in the form of the spline sleeve, which is preferably a thin-walled, toothed part or rollers held in a cage, having reduced manufacturing costs and reduced weight, can be utilized in order to transfer driving forces based on the configuration of the spline sleeve filling the gap between the teeth on the outer periphery of the PTU input shaft and on the inner periphery of the opening of the carrier. This provides a compact configuration having reduced weight and lower cost in comparison to the prior known types of sliding dog clutches, such as used in manual transmissions.

### BRIEF DESCRIPTION OF THE DRAWINGS

The foregoing Summary as well as the following Detailed Description will be best understood when read in conjunction with the appended drawings which show a preferred embodiment of the invention. In the drawings:

FIG. 1 is a schematic view of a vehicle drive train.

FIG. 2 is an exploded view of a spur gear differential with a rotary power transfer disconnect device used in connection with driving a PTU input shaft.

FIG. 3 is a view of the assembled rotary power transfer disconnect device located between the PTU input shaft and the differential.

FIG. 4 is a cross-sectional view showing the rotary power transfer disconnect device of FIG. 3 in the engaged, driving position.

FIG. 5 is a cross-sectional view taken along lines 5-5 in FIG. 4.

FIG. 6 is a view similar to FIG. 3 showing the rotary power transfer disconnect device between the PTU input shaft and the differential in the disengaged position.

FIG. 7 is view similar to FIG. 4 showing a cross-sectional view of the rotatory power transfer disconnect device in the disconnected position.

FIG. 8 is a view taken along line 8-8 in FIG. 7.

FIG. 9 is a perspective exploded view of a differential and a transmission with another embodiment of the rotary power transfer disconnect device according to the invention.

FIG. 10 is a portion of the exploded view from FIG. 9 in an enlarged view.

FIG. 11 is a partially assembled perspective view showing the differential input with the spline sleeve shown in a disengaged position along with the PTU input shaft.

FIG. 12 is an enlarged perspective view showing the spline sleeve located on the differential input with the locking ring defining an end travel position of the spline sleeve.

FIG. 13 is a cross-section view of the differential assembled with the transmission, and the rotary power disconnect device located therebetween in the disconnected position of the spline sleeve.

FIG. 14 is a view similar to FIG. 13 showing the spline sleeve in the engaged position such that power is transferred by the PTU input shaft to the differential.

FIG. 15 is an exploded view of another embodiment of a rotary power transfer disconnect device.

FIG. 16 is a cross-sectional view through the rotary power disconnect device of FIG. 15 in the coupled state.

FIG. 17 is longitudinal cross-sectional view taken along line 17-17 in FIG. 16.

FIG. 18 is an enlarged cross-sectional view taken along lines 18-18 in FIG. 17.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. These terms and terms of similar import are for ease of description when referring to the drawings and should not be considered limiting. “Axially” refers to a direction along the axis of a shaft. A reference to a list of items that are cited as “at least one of a, b, or c” (where a, b, and c represent the items being listed) means any single one of the items a, b, or c, or combinations thereof. The terms “teeth” and “splines” are used interchangeably herein.

For elements of the invention that are identical or have identical actions, identical reference symbols are used. The illustrated embodiments represent merely examples for how the device according to the invention could be equipped. They do not represent a conclusive limitation of the invention.

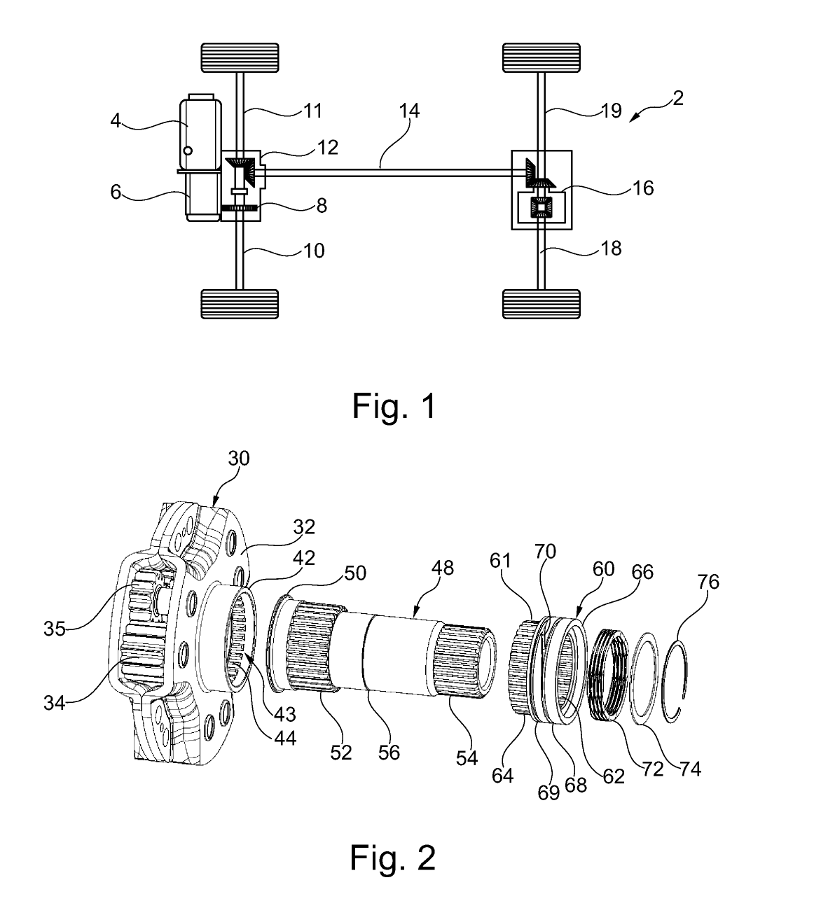

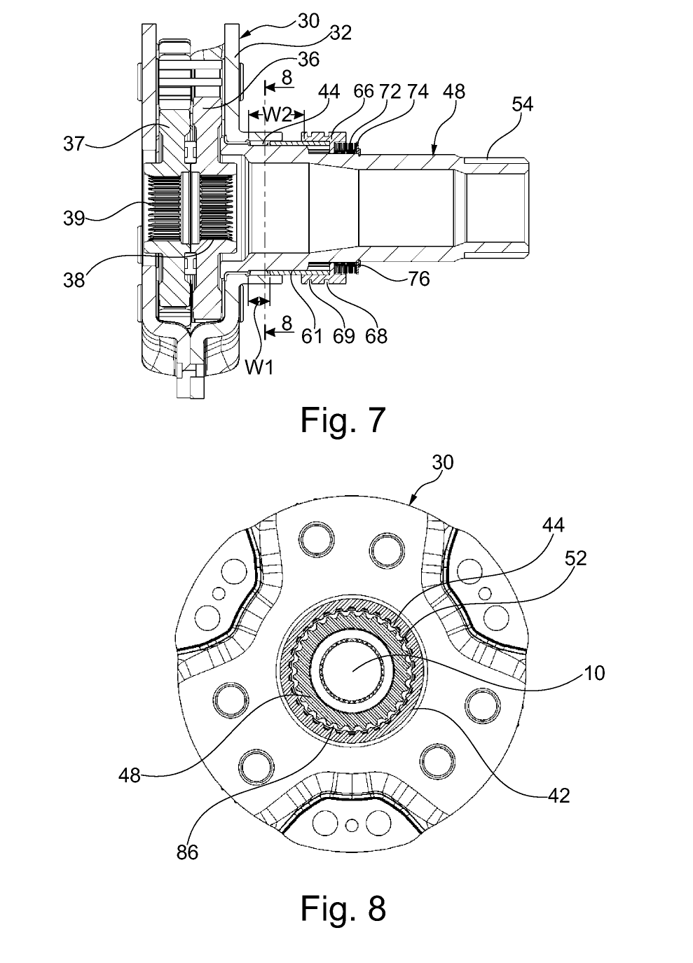

Referring to FIG. 2, a rotary power transfer disconnect device used in connection with a spur gear differential 30 is shown. While this preferred embodiment is for use in connection with a spur gear differential, such as disclosed in U.S. Patent Application Publications U.S. 2011/0045934 and U.S. 2011/0245012, both of which are incorporated herein by reference as if fully set forth, those skilled in the art will recognize that the present rotary power transfer power disconnect device can be used with other differentials and/or other rotary couplings and is not limited to this preferred arrangement. In one preferred embodiment shown in FIG. 2, the rotary power transfer disconnect device is located between the spur gear differential 30 and the power takeoff unit (PTU) input shaft 48, which are preferably arranged at the front differential 8 shown in FIG. 1. The spur gear differential 30 includes a carrier 32 which carries planet gears 34, 35 and two sun gears 36, 37. As shown in FIGS. 4 and 7, the sun gears 36, 37 include splines 38, 39 which are adapted to be connected to the left half axle and the right half axle 10, 11.

A collar 42 is located on the carrier 32 and includes internal splines or teeth 44. Here the carrier 32 forms a first drive part which has the opening 43 defined therein with the splines or teeth 44 defined at least around a portion of an inner periphery of the opening 43. In the preferred embodiment, the teeth 44 are defined around the entire periphery of the opening 43. The PTU input shaft 48 includes an annular flange 50 located at one end which is engaged behind the collar 42 of the carrier 32, as shown in FIG. 4. The PTU input shaft 48 includes a first set of splines 52 for engagement with the differential 30 on one end and a second set of splines 54 located at the other end which engage in the power takeoff unit 12 (FIG. 1). A groove 56 is also shown in FIG. 2 which is used in connection with the sliding dog clutch 60 which is arranged on the PTU input shaft 48. Here, the PTU input shaft 48 forms a second drive part that is at least partially received in the opening 43 in the first drive part in the form of the carrier 32. This second drive part includes splines or teeth, indicated as the teeth 52 in FIG. 2 which are defined around at least a portion of an outer periphery of the second drive part that extends into the opening 43.

A gap 86 (FIG. 8) is located between the teeth 44 on the inner periphery of the opening 43 of the first drive part (for example, the carrier 32) and the teeth 52 defined on the outer periphery of the second drive part (for example, PTU input shaft 48) that extends into the opening 43, with the gap being sized such that the first drive part is rotatable relative to the second drive part.

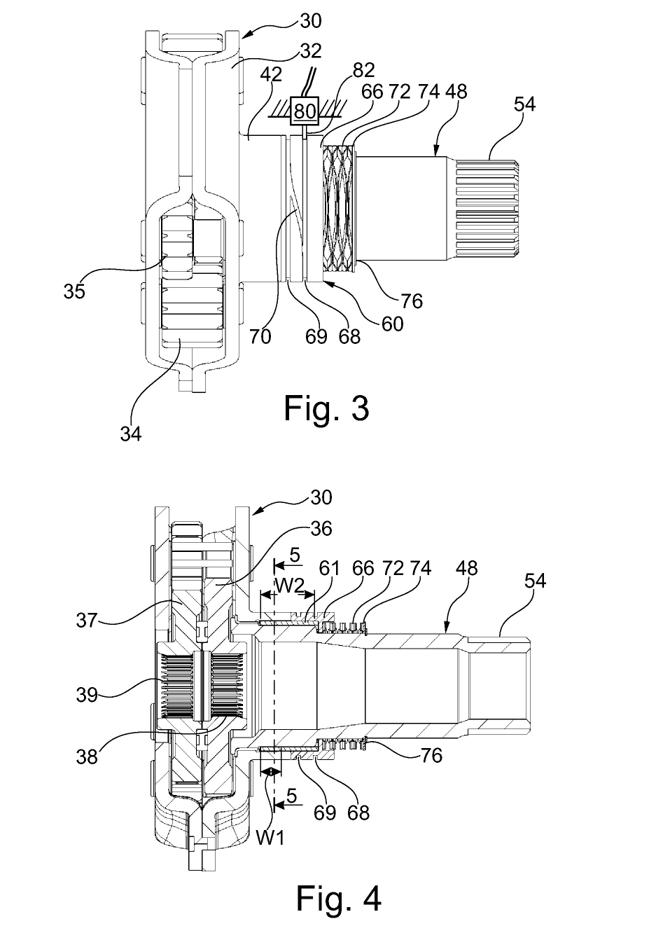

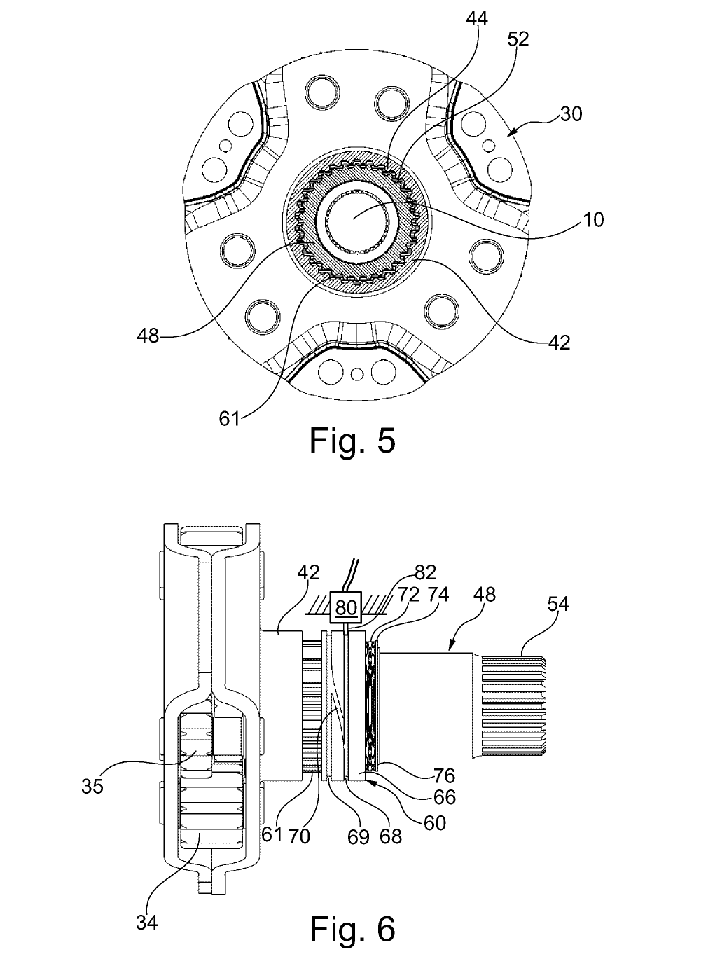

Referring to FIGS. 2-4, the sliding dog clutch 60 is shown in detail and includes a first embodiment of a spline sleeve 61, a cross-section of which is shown in FIG. 5. In this embodiment, the spline sleeve 61 includes internal projections in the form of teeth or splines 62 that are located on an inner periphery thereof that are engagable with, and preferably complementary to, the teeth 52 located on the outer periphery of the second drive part in the form of the PTU input shaft 48. The spline sleeve 61 also includes external projections in the form of teeth or splines 64 that are located on an outer periphery thereof that are engagable with, and preferably complementary to, the teeth 44 on the inner periphery of the opening 43 of the first drive part, in the form of the carrier 32. The sliding dog clutch 60 is slidable between a first position, in which the spline sleeve 61 is located in the gap 86 between the teeth or splines 44 on the inner periphery of the opening 43 of the first drive part in the form of the carrier 32 and the teeth or splines 52 defined on the outer periphery of the second drive part in the form of the PTU input shaft 48 that extends into the opening 43 (shown most clearly in FIGS. 3, 4, and 5), and a second position, in which the spline sleeve 61 is disengaged from the teeth 44 on the inner periphery of the opening 43 of the first drive part in the form of the carrier 32 or the teeth 52 defined on the outer periphery of the second drive part, preferably in the form of the PTU input shaft 48. When the spline sleeve 61 is in this second position, relative rotation is allowed between the first drive part in the form of the carrier 32 and the second drive part in the form of the PTU input shaft 48, for example when a vehicle drive line is in a front wheel only drive mode and the drive line for the rear wheels, including the drive shaft 14 as well as the rear differential 16 and preferably the rear axles 18 and 19 are all stationery.

Still with reference to FIGS. 2-4, the sliding dog clutch 60 preferably includes an actuator ring 66 that is connected to the spline sleeve 61. This actuator ring 66 includes annular grooves 68, 69 as well as a ramp groove 70 that extends between the annular grooves 68, 69. An actuator 80 is provided which is adapted to move the spline sleeve 61 between the first position, shown in FIGS. 3 and 4, and the second position, shown in FIGS. 6 and 7. The actuator 80 preferably includes an actuator pin 82 which can be extended and, due to rotation of the actuator ring 66 along with the first drive part in the form of the carrier 32 when the spline sleeve is located in the gap 86 in the first position, the pin engages in the ramp groove 70 and transitions to the second annular groove 69 resulting in the spline sleeve 61 being withdrawn from the gap 86 in order to disengage the spline sleeve 61 from the teeth 44 in the inner periphery of the opening 43 in the first drive part in the form of the carrier 32. One known pin actuator of this type is provided in U.S. Patent Application Publication U.S. 2012/0067689, which is incorporated herein by reference as if fully set forth. While a pin actuator 80 in connection with an actuator ring 66 is shown as one potential type of actuator, those skilled in the art will recognize that other types of actuators can be used in order to move the spline sleeve 61 into and out of engagement between the teeth 44 and 52 on opposite sides of the gap 86.

As shown in FIGS. 3, 4, 6, and 7, preferably the actuator ring 66 is biased toward the first position by spring 72 in the form of disk springs located on the PTU input shaft 48 and held in position via a retainer ring 74 and a lock ring 76 which engages in the groove 56 in the PTU input shaft 48 shown in FIG. 2.

Still with reference to FIGS. 2-4, it can be seen that the first preferred embodiment of the spline sleeve 61 is a thin-walled part, and is preferably also a deep drawn part formed of sheet metal which can be attached to the actuator ring 66 via an interference fit, bonding or welding. A preferred range of wall thicknesses is in the range of 0.062 to 0.125 inches. However, other smaller or larger sizes can be used depending on the load being transferred, the sleeve diameter, tooth configuration, etc. As shown in FIG. 8, the valleys between the inner teeth 62 can be located in that area of the external teeth 64 providing a generally constant wall thickness for the first embodiment of the spline sleeve 61. Preferably this spline sleeve 61/actuator ring 66 assembly is slidable on the second drive part in the form of the PTU input shaft 48 and guided by the teeth 52 defined on the outer periphery of the PTU input shaft 48 which are sufficiently long enough to allow for the required travel so that the spline sleeve can be drawn out from the overlap area with the teeth 44, indicated by the width W1. However, it would be possible to reverse this arrangement and have the spline sleeve 61 slide on the opposite part, i.e., on the collar 42 or another part on the spur gear differential 30, depending on the particular coupling/disconnect application.

Referring to FIGS. 4 and 7, the teeth 44 in the inner periphery of the opening 43 of the first drive part in the form of the carrier 32 preferably have a first width W1 and the teeth 52 define on the outer periphery of the second drive part in the form of the PTU input shaft 48 have a second width W2. As shown in FIG. 4, when the spline sleeve 61 is in the first position it is located in the overlapping area between W1 and W2, as shown in FIG. 4, providing a keyed driving connection between the first part and the second part by the sliding sleeve 61 generally filling the gap 86, as shown in FIG. 5. This arrangement provides for a direct coupling between the first and second parts where the load is carried in both shear and compressive forces between the inner teeth 52 on the one side and the outer teeth 44 on the other side based on the axially overlapping arrangement of the teeth 44, 52 as well as the sliding spline 61. Accordingly, the spline sleeve does not have to be designed to carry the full torsional load being transferred. In comparison, in FIG. 7, it can be seen that the sliding spline 61 has been axially moved so that it no longer overlaps with the width W1 of the teeth 44 located on the inner periphery of the opening 43 of the first drive part (carrier 32). This results in the gap 86 between the inner teeth 52 and outer teeth 44 being open, allowing free rotation between the PTU input shaft 48 and the carrier 32. The longer width W2 of the teeth 52 allows them to act as a sliding guide for the spline sleeve 61 on the PTU input shaft 48.

This arrangement allows for a very axially compact configuration of a rotary power transfer disconnect device which can also be produced using a thin-walled coupling part in the form of the spline sleeve 61 which can be produced more cheaply as a deep drawn part and with a reduced weight in comparison with the prior known sliding dog clutches typically used to couple axially abutting drive parts with a coupling that spans the gap between them in order to carry the torsional load from one part to the next.

In one particularly preferred application, the present rotary power transfer disconnect device can be used in conjunction with the arrangement of U.S. 2012/0067689 to disconnect the drive line at the rear wheel bearings in a vehicle drive train 2 such as shown in FIG. 1 so that the drive line for the rear wheels is totally isolated when the all-wheel drive feature is not being utilized in order to reduce fuel consumption.

As previously noted, while only one preferred application of the present invention is a rotary power transfer disconnect device used between a spur gear differential 30 and a power takeoff unit 12 which is powered by the PTU input shaft 48, those skilled in the art will recognize that the rotary power transfer disconnect device according to the present invention can have many applications in other types of rotary drives where a compact configuration is required. This is particularly useful to reduce cost and allows for the use of light weight components for the coupling in the form of the spline sleeve that is insertable between the axially overlapping teeth of the two drive parts.

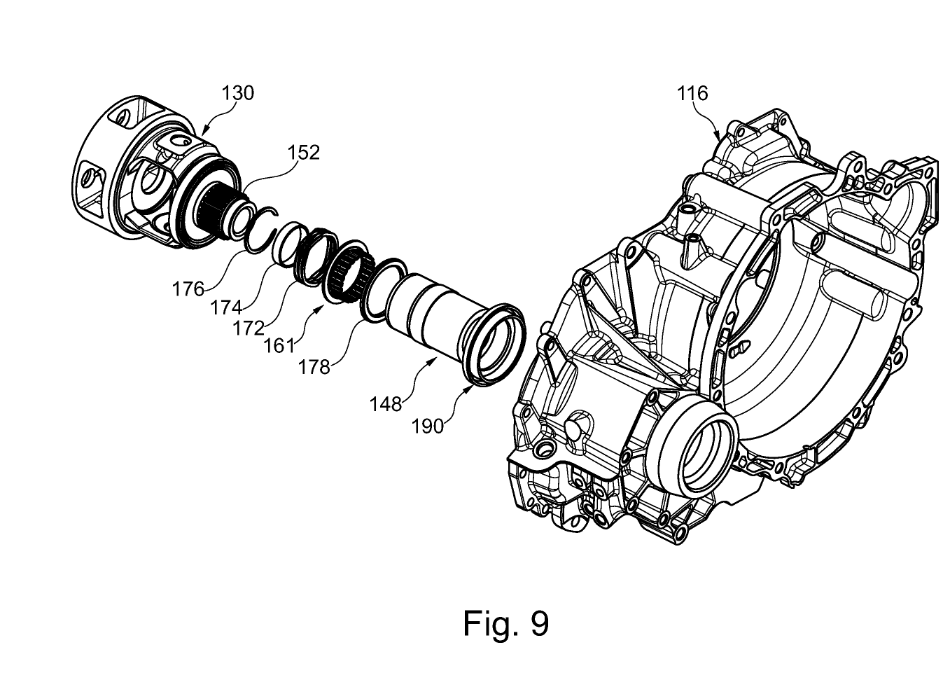

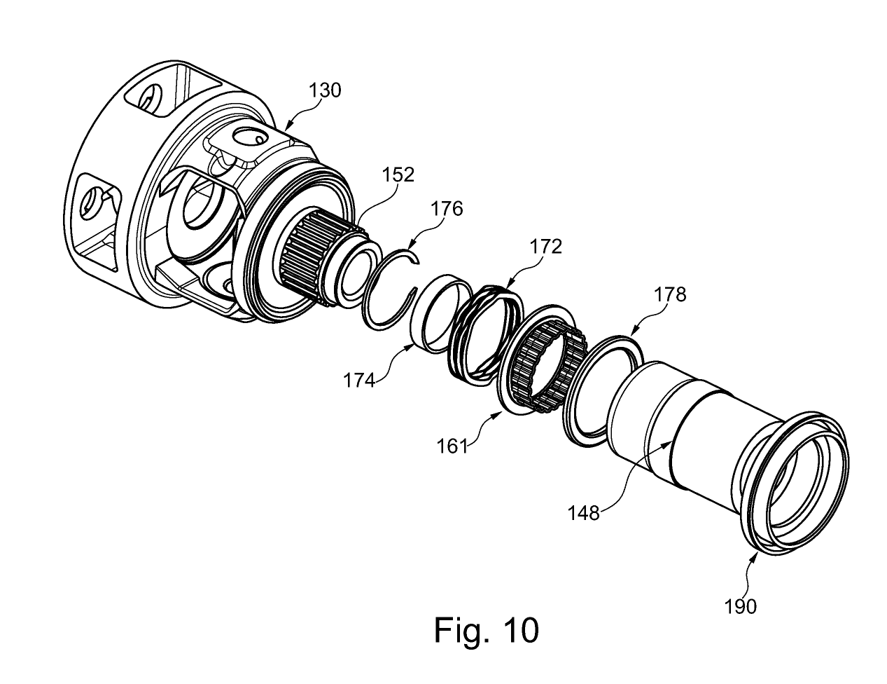

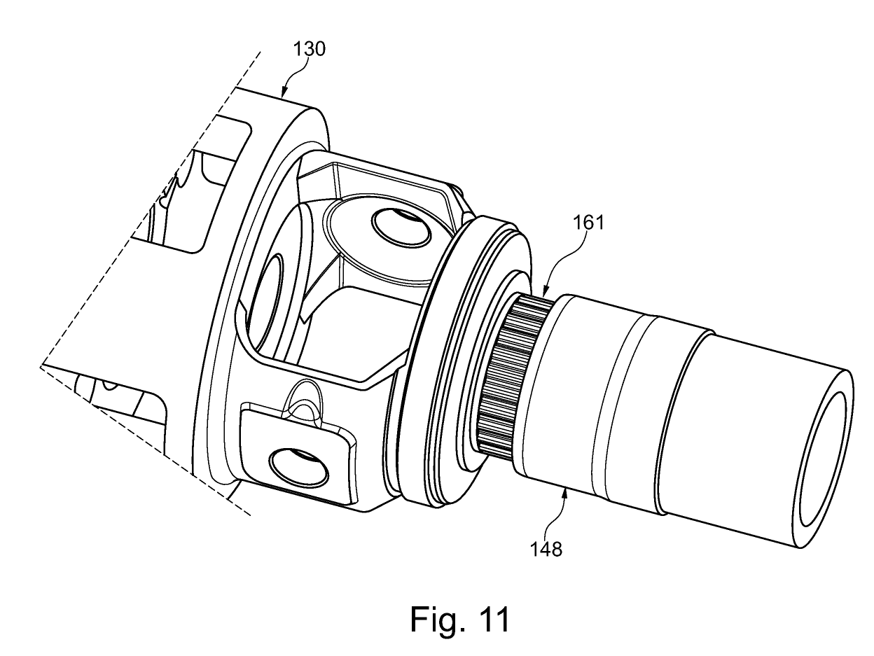

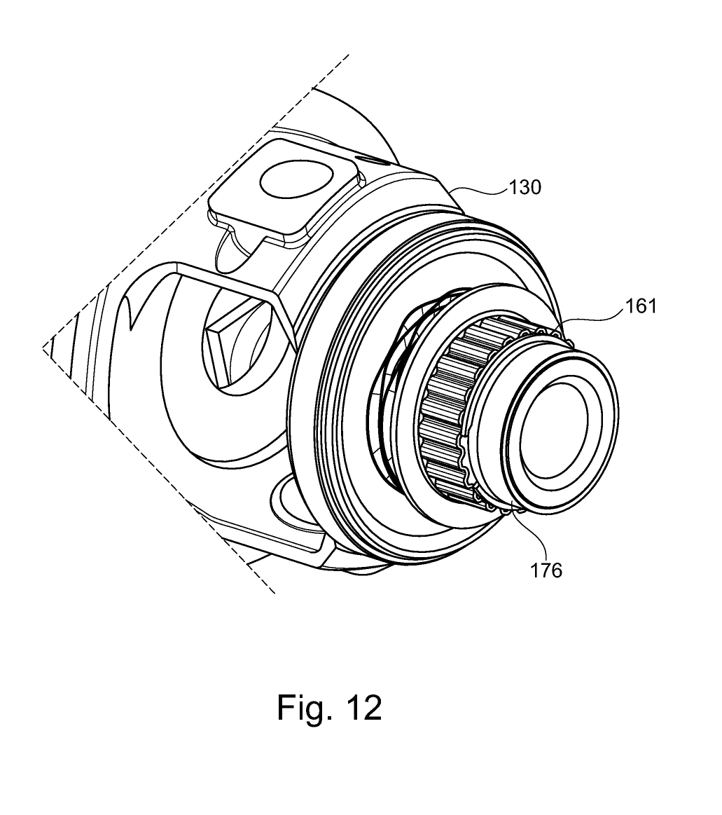

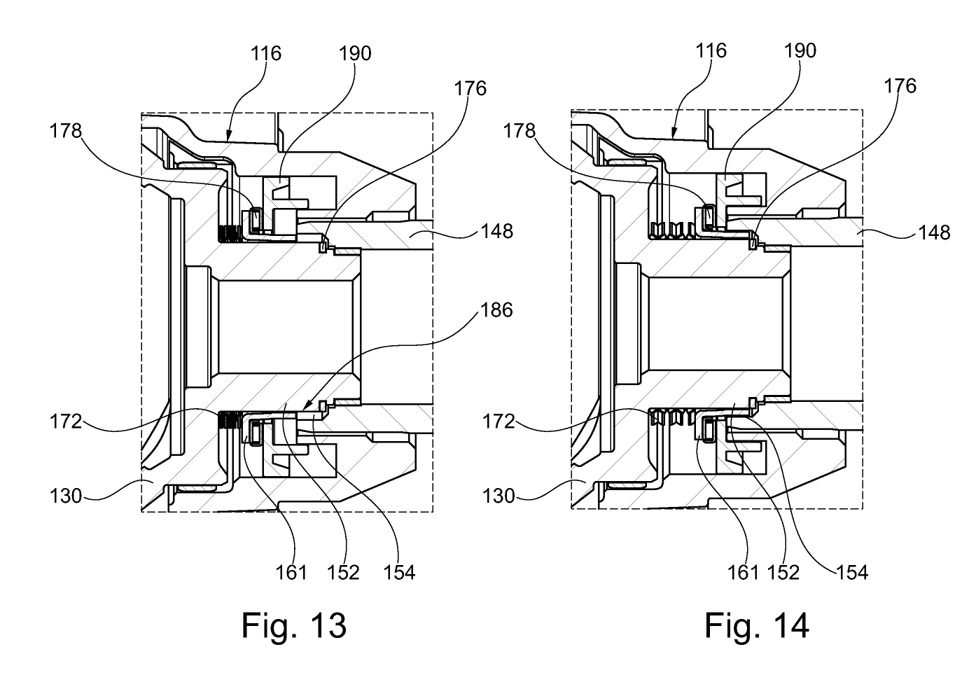

Referring now to FIGS. 9-14, another embodiment of the rotary power transfer disconnect device according to the invention for use between a transmission 116 and a differential 130 is shown. Here, the first drive part is formed by the PTU shaft 148 which, as shown in FIGS. 13 and 14 includes teeth 154 defined around at least a portion of an inner periphery of the opening. The second drive part is here formed by the differential input shown with teeth 152 around at least a portion of an outer periphery thereof in FIGS. 9, 10, 13 and 14, that extend into the opening in the PTU input shaft 148. As best shown in FIG. 13, which shows the power transfer disconnect device in the disconnected position, a gap 186 is located between the teeth 154 in the inner periphery of the opening in the PTU and the teeth 152 defined on the outer periphery of the differential input. The spline sleeve 161 is similar to the spline sleeve 61 described above and includes both internal and external splines which are adapted to engage with the teeth 152 on the differential input as well as the teeth 154 on the inner periphery of the PTU shaft 148. In this embodiment, the spline sleeve 161 is held in the disconnected position shown in FIG. 13 via hydraulic oil pressure acting against the annular piston 191 carried in the housing of the transmission 116, as shown best in FIGS. 13 and 14. When hydraulic pressure is acting behind the piston 190, it presses the spline sleeve 161 against the spring 172 seated against the differential 130 via a rolling bearing 178, which is preferably in the form of a needle roller bearing. The needle roller bearing isolates the rotation of the differential 130 from the piston 190 in the stationery housing of the transmission 116. When the hydraulic pressure is not applied to the piston 190, the spring 172 forces the spline sleeve 161 into the engaged position wherein the external splines on the spline sleeve 161 engage with the internal teeth 154 of the PTU shaft 148 and the internal teeth of the spline sleeve remain engaged with the teeth 152 on the outside of the differential input and slide up to the stop provided by lock ring 176. In this embodiment, the default position is the engaged position with the spring 172 holding the spline sleeve 161 in the engaged position as shown in FIG. 14.

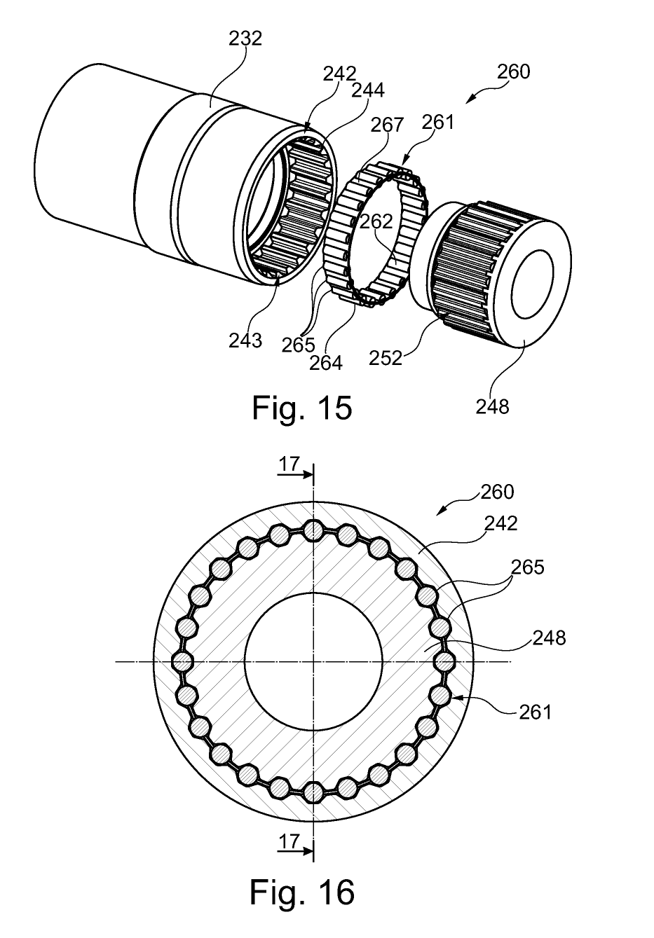

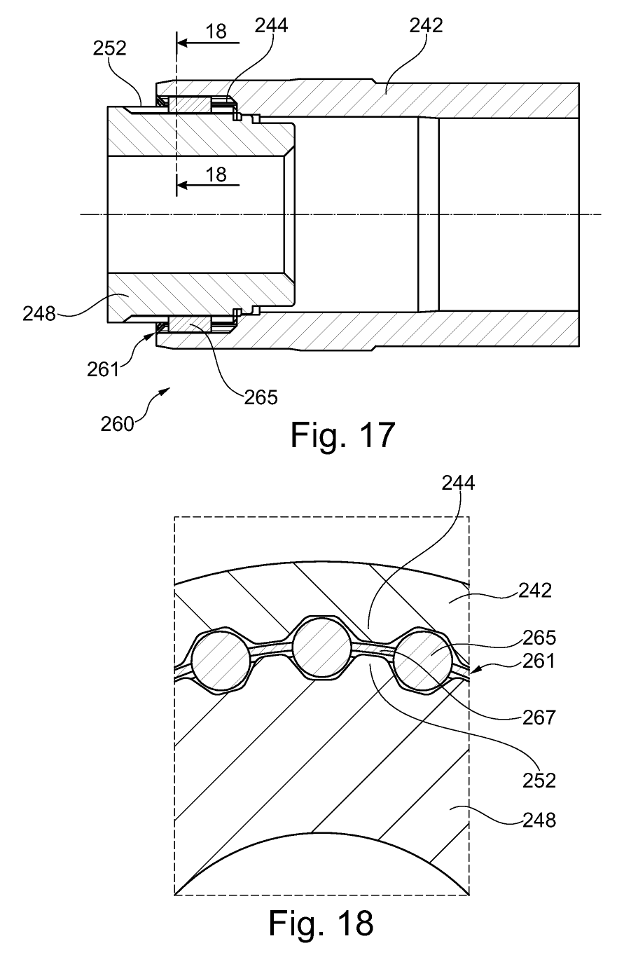

Referring to FIGS. 15-18, another embodiment of the rotary power transfer disconnect device with a sliding dog clutch 260, similar to the sliding dog clutch 60, is shown which includes a further preferred embodiment of the spline sleeve 261. The sliding dog clutch 260 is similar to the sliding dog clutch 60, and the differences will be described in detail below. In the sliding dog clutch 260, the spline sleeve 261 is formed by rollers 265 held in a cage 267. The rollers 265 form the internal projections 262 with their radially inwardly directed portions that are engagable with the teeth 252 located on the outer periphery of the second drive part 248. The spline sleeve 261 also includes external projections 264 formed by the radially outwardly directed portions of the rollers 265 that are engagable with the teeth 244 on the inner periphery of the collar 242 of the first drive part 232. The sliding dog clutch 260 is slidable between a first position, in which the spline sleeve 261 is located in the gap between the teeth or splines 244 on the inner periphery of the opening 243 of the first drive part and the teeth or splines 252 defined on the outer periphery of the second drive part 248 that extends into the opening 243 (shown most clearly in FIGS. 16-18), and a second position, in which the spline sleeve 261 is disengaged from the teeth 244 on the inner periphery of the opening 243 of the first drive part 232 or the teeth 252 defined on the outer periphery of the second drive part 248. When the spline sleeve 261 is in this second position, relative rotation is allowed between the first drive part 232 and the second drive part 248.

The sliding dog clutch 260 can be actuated in the same manner as either of the prior embodiments by forming or connecting an actuator ring on the cage 265.

The use of rollers 265 in the spline sleeve allows for greater tolerance deviations between the teeth or splines 244, 252 on the first or second drive parts 232, 248, eliminating or reducing edge loading on the teeth or splines, and allowing for further reduction in manufacturing costs.

While the preferred embodiment shows the axially overlapping teeth extending around the complete inner and outer peripheries of the respective drive parts, those skilled in the art that an arrangement could be utilized in which the teeth are only located over a portion of the outer periphery, for example in a cross-shaped arrangement where the teeth are only located at 0°, 90°, 180°, and 270°. The specific arrangement of the teeth or splines will depend on the loads being carried and the particular application, which will be apparent to a person of ordinary skill in the art in view of the present disclosure.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

1. A rotary power transfer disconnect device, comprising:
a first drive part having an opening defined therein, with teeth defined around at least a portion of an inner periphery of the opening;
a second drive part that is at least partially received in the opening in the first drive part, the second drive part having teeth defined around at least a portion of an outer periphery that extends into the opening,
a gap being located between the teeth on the inner periphery of the opening of the first drive part and the teeth defined on the outer periphery of the second drive part that extends into the opening so that the first drive part is rotatable relative to the second drive part; and
a sliding dog clutch having a spline sleeve with internal projections located on an inner periphery thereof that are engagable with the teeth on the outer periphery of the second drive part and external projections located on an outer periphery thereof that are engagable with the teeth on the inner periphery of the opening of the first drive part, the sliding dog clutch being slidable between a first position in which the spline sleeve is located in the gap, providing a driving engagement between the first drive part and the second drive part, and a second position, in which the spline sleeve is disengaged from the teeth on the inner periphery of the opening of the first drive part or the teeth defined on the outer periphery of the second drive part, allowing relative rotation between the first drive part and the second drive part.

2. The rotary power transfer disconnect device of claim 1, wherein the spline sleeve is a thin-walled part, and the internal projections are formed as internal teeth located on an inner periphery of the thin-walled part that are complementary to the teeth on the outer periphery of the second drive part and the external projections are formed as external teeth located on an outer periphery of the thin-walled part that are complementary to the teeth on the inner periphery of the opening of the first drive part.

3. The rotary power transfer disconnect device of claim 2, wherein the spline sleeve is a deep drawn part and is attached to an actuator ring.

4. The rotary power transfer disconnect device of claim 1, wherein the spline sleeve comprises rollers held in a cage, and radially inwardly directed portions of the rollers form the internal projections and radially outwardly directed portions of the rollers form the external projections.

5. The rotary power transfer disconnect device of claim 1, wherein the spline sleeve is slidable on the second drive part, guided by the teeth defined on the outer periphery of the second drive part.

6. The rotary power transfer disconnect device of claim 1, wherein the teeth on the inner periphery of the opening of the first drive part have a first width (W1) and the teeth defined on the outer periphery of the second drive part have a second width (W2), and W1<W2.

7. The rotary power transfer disconnect device of claim 1, further comprising an actuator adapted to move the spline sleeve between the first position and the second position.

8. The rotary power transfer disconnect device of claim 7, further comprising an actuator ring connected to the spline sleeve, the actuator ring including actuating grooves that are engaged by an actuator pin of the actuator in order to move the spline sleeve to the second position.

9. The rotary power transfer disconnect device of claim 7, further comprising a spring that biases the spline sleeve to the first position.

10. The rotary power transfer disconnect device of claim 7, wherein the actuator is a hydraulic piston that presses against the spline sleeve via a rolling bearing.

11. The rotary power transfer disconnect device of claim 1, wherein the first drive part is a differential carrier and the second drive part is a power take off unit input shaft.

12. The rotary power transfer disconnect device of claim 11, wherein the spline sleeve is slidable on the power take off unit input shaft against a spring force of a spring located on the power take off unit input shaft, the spring is held in position on the power take off unit input shaft by a locking ring engaged in an annular groove on the power take off unit input shaft.

13. The rotary power transfer disconnect device of claim 11, wherein the power take off unit input shaft includes an annular flange that engages behind the opening in the differential carrier.

14. The rotary power transfer disconnect device of claim 11, wherein the differential carrier carries spur gears and two sun gears of a spur gear differential.

15. The rotary power transfer disconnect device of claim 1, wherein the first drive part is a power take off unit input shaft and the second drive part is a differential input.

16. The rotary power transfer disconnect device of claim 15, wherein the spline sleeve is slidable via a hydraulic actuator on the differential input against a spring force of a spring located on the differential.

17. A spur gear differential with a power take off unit (PTU) connection, comprising:
a carrier with an opening defined therein, the carrier housing two sun gears and two sets of planet gears, the sun gears including splined openings adapted to receive splined ends of axles,
a collar located on the carrier having an opening with splines located on an inner periphery thereof adapted for driving connection of a PTU input shaft, the PTU input shaft having teeth defined around at least a portion of an outer periphery that extends into the opening,
a gap being located between the teeth on the inner periphery of the opening of the collar and the teeth defined on the outer periphery of the PTU input shaft that extends into the opening so that the carrier with the collar is rotatable relative to the PTU input shaft; and
a sliding dog clutch having a spline sleeve with internal projections located on an inner periphery thereof that are engagable with the teeth on the outer periphery of the PTU input shaft and external projections located on an outer periphery thereof that are engagable with the teeth on the inner periphery of the opening of the collar, the sliding dog clutch being slidable between a first position in which the spline sleeve is located in the gap, providing a driving engagement between the collar of the carrier and the PTU input shaft, and a second position, in which the spline sleeve is disengaged from the teeth on the inner periphery of the opening of the collar of the carrier or the teeth defined on the outer periphery of the PTU input shaft, allowing relative rotation between the carrier and the PTU input shaft.
